(19) United States
(12) Patent Application Publication
(10) Pub. No.: US 2026/0251351 A1
(43) Pub. Date: Aug. 27, 2026

(54) LIQUID HEATING DEVICE

(71) Applicant: Toshiba Lighting & Technology Corporation, Kanagawa (JP)

(72) Inventors: Satoko KATO, Ehime-ken (JP); Masahiko TAMAI, Kanagawa-ken (JP); Yoshihiro KUSUHASHI, Ehime-ken (JP); Akio TSUBOUCHI, Ehime-ken (JP); Kousuke UENO, Ehime-ken (JP); Masahiro DOI, Ehime-ken (JP); Tsuyoshi OHASHI, Ehime-ken (JP); Yumi MINEYAMA, Ehime-ken (JP); Kairi TAMURA, Ehime-ken (JP); Misaki AONAMI, Ehime-ken (JP)

(73) Assignee: Toshiba Lighting & Technology Corporation, Kanagawa (JP)

(21) Appl. No.: 19/262,132

(22) Filed: Jul. 8, 2025

(30) Foreign Application Priority Data
Feb. 27, 2025 (JP) 2025-029669

(51) Int. Cl. F24H 1/20; F24H 9/1818

(52) U.S. Cl. CPC F24H 1/202; F24H 9/1818

(57) ABSTRACT

A liquid heating device according to an embodiment includes: a container having a space inside to which a liquid is supplied; a base part having a plate shape, and including a first portion provided in the space inside the container, and a second portion provided at a periphery of the first portion and exposed to the outside of the container; a heating element provided on a first side of the first portion; a terminal provided on the first side of the second portion; a connection part provided on the first side of the first portion and the second portion, and electrically connected to the heating element and the terminal; a protection part provided on the first side of the first portion and the second portion, covering the heating element and the connection part, and exposing the terminal; and a sealing part provided between the container and the second portion. The sealing part is provided at an end portion on an upper side in a gravity direction of the container.

### CROSS-REFERENCE TO RELATED APPLICATION

This application claims the priority benefits of Japanese application no. 2025-029669, filed on Feb. 27, 2025. The entirety of the above-mentioned patent application is hereby incorporated by reference herein and made a part of this specification.

### BACKGROUND

### Technical Field

Embodiments of the disclosure relate to a liquid heating device.

### Description of Related Art

There is a liquid heating device that heats a liquid such as water. The liquid heating device is equipped with, for example, a container having a space inside to which the liquid to be heated is supplied, and a heater provided in the space inside the container and converting the applied electric power into joule heat.

In recent years, there has been a demand for miniaturization of the liquid heating device and improvement of the liquid heating efficiency.

Here, a heater has been proposed that has a base part having a plate shape, a heating element provided on one surface side of the base part and extending in a direction in which the base part extends, a terminal for applying electric power to the heating element, and a connection part electrically connecting the heating element and the terminal. If such a heater is provided in the space inside the container, it is possible to achieve miniaturization of the container and thus miniaturization of the liquid heating device. Besides, if such a heater is provided in the space inside the container, the liquid supplied to the space inside the container can be directly heated, making it possible to improve the heating efficiency for the liquid.

However, a controller or the like provided outside the container is electrically connected to the terminal of the heater via a cable. Therefore, if the heater is simply provided in the space inside the container, there is a concern that the liquid may leak to the outside of the container from the hole through which the cable of the container is inserted. If the liquid leaks to the outside of the container, members around the container may corrode or the periphery of the container may become dirty.

Thus, it has been desired to develop a liquid heating device that is capable of suppressing leakage of the liquid to the outside of the container even in a case where the heater is provided in the space inside the container.

### RELATED ART DOCUMENT

### Patent Document

[Patent Document 1] Japanese Patent Application Laid-Open No. 2001-223068

The disclosure provides a liquid heating device that is capable of suppressing leakage of a liquid to the outside of a container even in a case where a heater is provided in a space inside the container.

### SUMMARY

A liquid heating device according to an embodiment includes: a container having a space inside to which a liquid is supplied; a base part having a plate shape, and including a first portion provided in the space inside the container, and a second portion provided at a periphery of the first portion and exposed to the outside of the container; a heating element provided on a first side of the first portion; a terminal provided on the first side of the second portion; a connection part provided on the first side of the first portion and the second portion, and electrically connected to the heating element and the terminal; a protection part provided on the first side of the first portion and the second portion, covering the heating element and the connection part, and exposing the terminal; and a sealing part provided between the container and the second portion. The sealing part is provided at an end portion on an upper side in a gravity direction of the container.

According to an embodiment of the disclosure, it is possible to provide a liquid heating device that is capable of suppressing leakage of a liquid to the outside of a container even in a case where a heater is provided in a space inside the container.

### BRIEF DESCRIPTION OF DRAWINGS

FIG. 1 is a schematic perspective view for illustrating a liquid heating device according to the present embodiment.

FIG. 2 is a schematic plan view of a heater when viewed from the side where a heat generation part is provided.

FIG. 3 is a schematic cross-sectional view of the heater in FIG. 2 along the A-A line direction.

FIG. 4 is a schematic perspective view for illustrating a liquid heating device according to another embodiment.

FIG. 5 is a schematic plan view of a heater when viewed from the side where a heat generation part is provided.

FIG. 6 is a schematic plan view of a heater according to another embodiment when viewed from the side where a heat generation part is provided.

FIG. 7 is a schematic view for illustrating a container extending in the substantially gravity direction.

FIG. 8 is a schematic view for illustrating a container extending in a direction inclined with respect to the horizontal direction.

### DESCRIPTION OF EMBODIMENTS

Hereinafter, embodiments will be exemplified with reference to the drawings. In each drawing, similar constituent elements are denoted by the same reference numerals, and detailed descriptions thereof will be omitted where appropriate.

In addition, arrow X, arrow Y, and arrow Z in each drawing represent directions that intersect with each other. For example, the X direction (corresponding to one example of the first direction) can be the longitudinal direction of a heater 2. For example, the Y direction can be the transverse direction (width direction) of the heater 2. For example, the Z direction can be the thickness direction of the heater 2.

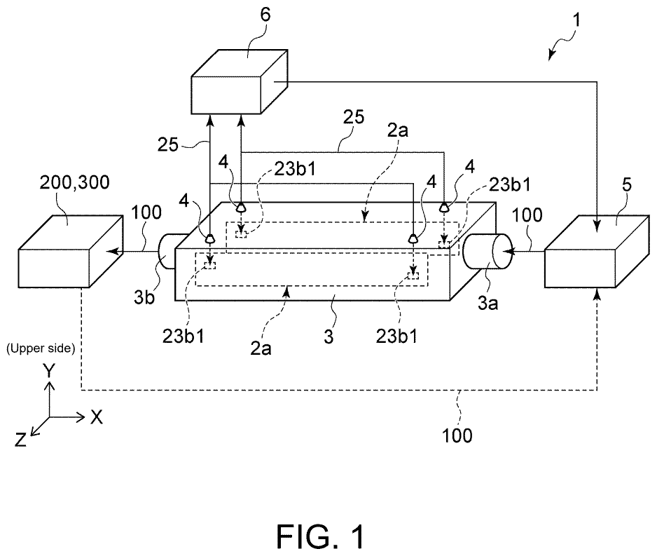

FIG. 1 is a schematic perspective view for illustrating a liquid heating device 1 according to the present embodiment.

In FIG. 1, the Y direction is set as the upper side in a gravity direction.

As shown in FIG. 1, the liquid heating device 1 includes, for example, the heater 2, a container 3, a sealing part 4, a supply part 5, and a controller 6.

As one example, FIG. 1 illustrates a case where two heaters 2 are provided. However, the number of heaters 2 is not limited thereto. At least one heater 2 may be provided.

In addition, the heater 2 is, for example, in contact with a liquid 100 flowing through a space inside the container 3, and heats the liquid 100. The liquid 100 is, for example, water, a solution (for example, coolant liquid), or the like. However, the type of the liquid 100 is not limited to those exemplified.

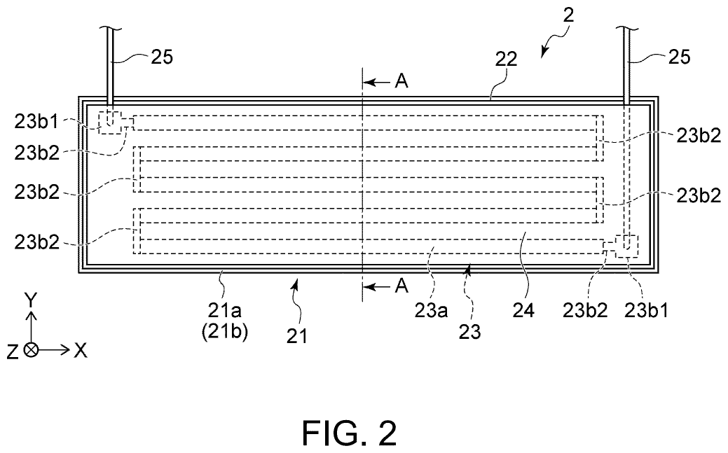

FIG. 2 is a schematic plan view of the heater 2 when viewed from the side where a heat generation part 23 is provided.

FIG. 3 is a schematic cross-sectional view of the heater 2 in FIG. 2 along the A-A line direction.

As shown in FIG. 2 and FIG. 3, the heater 2 has, for example, a base part 21, an insulation part 22, the heat generation part 23, and a protection part 24.

The base part 21 has a plate shape, and has a surface 21a and a surface 21b facing the surface 21a. The base part 21 is provided in the space inside the container 3. The base part 21 extends in the X direction. The shape of the base part 21 when viewed from the Z direction is, for example, rectangular. The shape of the base part 21 when viewed from the Z direction can be appropriately changed according to the shape of the container 3, etc. For example, the shape of the base part 21 when viewed from the Z direction may be a circle, an ellipse, a part of a circle or ellipse, a polygon, a part of a polygon, or the like.

The dimensions of the base part 21 in the X direction and the Y direction (the length dimension and the width dimension of the base part 21) can be appropriately changed according to the dimensions of the space inside the container 3 where the heater 2 is provided, the number of the heat generation parts 23, the dimensions of the heat generation part 23 in the X direction and the Y direction, or the like. The dimension of the base part 21 in the Z direction (the thickness dimension of the base part 21) can be appropriately changed according to the force applied to the heater 2 when the liquid 100 flows through the inside of the container 3.

The base part 21 is made of a material having heat resistance and high thermal conductivity. For example, the base part 21 can be made of metals such as stainless steel or aluminum alloy, or inorganic materials such as ceramics.

Here, the thermal conductivity of metals is higher than the thermal conductivity of inorganic materials such as ceramics. Therefore, in a case where the base part 21 includes a metal, the time for temperature rise of the heater 2 can be shortened. In addition, the rigidity of metals is higher than the rigidity of inorganic materials such as ceramics. Therefore, in a case where the base part 21 includes a metal, the rigidity of the heater 2 can be improved. As a result, damage to the heater 2 can be suppressed when the liquid 100 flows through the inside of the container 3.

On the other hand, inorganic materials such as ceramics generally have insulating properties. Therefore, in a case where the base part 21 includes a material having insulating properties, the insulation part 22 described later can be omitted. For example, in a case where the base part 21 includes a material having insulating properties, the heat generation part 23 can be provided directly on the base part 21. Additionally, in a case where the base part 21 includes a material having insulating properties, occurrence of short circuit or electrical leakage can be suppressed even when heating a liquid 100 having conductivity.

The heater 2 illustrated in FIG. 1 and FIG. 2 includes the base part 21 including a metal. Therefore, the insulation part 22 is provided between the heat generation part 23 and the base part 21.

The insulation part 22 is, for example, provided on the surface 21a of the base part 21. The insulation part 22 insulates between the base part 21 having conductivity and the heat generation part 23. Therefore, the insulation part 22 covers at least a region where the heat generation part 23 is provided on the surface 21a of the base part 21. That is, the insulation part 22 is provided between the base part 21 and a heating element 23a, a terminal 23b1, and a connection part 23b2.

The thickness of the insulation part 22 is not particularly limited as long as insulating properties can be ensured. The insulation part 22 is made of a material having heat resistance and insulating properties. The insulation part 22 can be made of, for example, ceramics or glass. The insulation part 22 can be formed by, for example, thermal spraying or firing.

The heat generation part 23 includes, for example, the heating element 23a and a wiring 23b. The heating element 23a and the wiring 23b are, for example, provided on the surface 21a side of the base part 21 (corresponding to one example of the first side). In a case where the base part 21 includes a material having conductivity, the heating element 23a and the wiring 23b are provided on the insulation part 22. In a case where the base part 21 includes a material having insulating properties, the heating element 23a and the wiring 23b are provided directly on the surface 21a of the base part 21.

The heating element 23a converts applied electric power into heat (joule heat). For example, the heating element 23a has a linear shape and extends in the X direction. The electrical resistance value per unit length of the heat generation part 23 can be set substantially uniform in the X direction, or can be set different. For example, the electrical resistance value per unit length of the heating element 23a illustrated in FIG. 2 is substantially uniform in the X direction. For example, the dimension in the Y direction (width dimension) and the dimension in the Z direction (thickness dimension) of the heating element 23a are substantially constant. In a case of changing the electrical resistance value per unit length of the heating element 23a, at least one of the width dimension and thickness dimension may be changed.

In addition, in the heater 2 illustrated in FIG. 1 and FIG. 2, five heating elements 23a are provided on the surface 21a side of the base part 21, but at least one heating element 23a can be provided. In a case where multiple heating elements 23a are provided, multiple heating elements 23a can be arranged with predetermined intervals in the Y direction.

Further, in a case where multiple heating elements 23a are provided, the length dimension, width dimension, and thickness dimension of the heating elements 23a may be the same, or at least one of the length dimension, width dimension, and thickness dimension of the heating elements 23a may be different. In the heater 2 illustrated in FIG. 2 and FIG. 3, the length dimension, width dimension, and thickness dimension of five heating elements 23a are substantially the same.

Moreover, in a case where multiple heating elements 23a are provided, multiple heating elements 23a can be connected in series connection, multiple heating elements 23a can be connected in parallel connection, or multiple heating elements 23a can be connected in series-parallel connection. In the heater 2 illustrated in FIG. 2 and FIG. 3, five heating elements 23a are connected in series connection.

The number, arrangement, length dimension, width dimension, thickness dimension, and connection configuration of the heating elements 23a can be appropriately changed according to the heat generation amount required for the heater 2, the size of the container 3 in which the heater 2 is provided, or the like.

The heating element 23a can be formed using, for example, ruthenium oxide (RuO₂), silver-palladium (Ag—Pd) alloy, silver-platinum (Ag—Pt) alloy, or the like. The heating element 23a can be formed by, for example, applying a paste-like material on the insulation part 22 using a screen printing method or the like, and curing the material using a firing method or the like. In a case where the base part 21 includes a material having insulating properties, the heating element 23a can be formed by, for example, applying a paste-like material on the surface 21a of the base part 21 using a screen printing method or the like, and curing the material using a firing method or the like.

The wiring 23b includes, for example, the terminal 23b1 and the connection part 23b2.

A pair of terminals 23b1 can be provided, for example. The pair of terminals 23b1 are electrically connected to the heating element 23a via the connection part 23b2. The terminal 23b1 can be provided, for example, in the vicinity of an end portion of the base part 21 in the X direction. In the heater 2 illustrated in FIG. 2, one terminal 23b1 is provided in the vicinity of one end portion of the base part 21 in the X direction, and one terminal 23b1 is provided in the vicinity of the other end portion of the base part 21 in the X direction. The pair of terminals 23b1 may be provided in the vicinity of one end portion of the base part 21 in the X direction. The arrangement of the pair of terminals 23b1 can be appropriately changed according to the number of heating elements 23a, the connection configuration of heating elements 23a, or the like.

In addition, each of the pair of terminals 23b1 is electrically connected to the controller 6 via a cable 25. The cable 25 is electrically connected to the terminal 23b1 and is drawn to the outside of the container 3. One end portion of the cable 25 is, for example, soldered to the terminal 23b1. The cable 25 can be, for example, a waterproof cable.

The connection part 23b2 is provided, for example, to connect multiple heating elements 23a in series connection, parallel connection, or series-parallel connection. In FIG. 2, five heating elements 23a are connected in series connection by four connection parts 23b2. In a case where one heating element 23a is provided, the connection part 23b2 can be omitted.

Furthermore, the connection part 23b2 can also electrically connect the heating element 23a and the terminal 23b1. In this way, it becomes easy to arbitrarily change the positions of the pair of terminals 23b1.

The terminal 23b1 and the connection part 23b2 are formed using, for example, a material including silver, copper, or the like. The terminal 23b1 and the connection part 23b2 can be formed by, for example, applying a paste-like material on the insulation part 22 using a screen printing method or the like, and curing the material using a firing method or the like. In a case where the base part 21 includes a material having insulating properties, the terminal 23b1 and the connection part 23b2 can be formed by, for example, applying a paste-like material on the surface 21a of the base part 21 using a screen printing method or the like, and curing the material using a firing method or the like.

The protection part 24 is provided on the side of the base part 21 where the heat generation part 23 is provided (corresponding to one example of the first side). The protection part 24 is provided, for example, on the insulation part 22, and covers the heating element 23a, the terminal 23b1, the connection part 23b2, and the connection portion of the cable 25 with the terminal 23b1. In a case where the base part 21 includes a material having insulating properties, the protection part 24 is provided directly on the surface 21a of the base part 21, for example, and covers, for example, the heating element 23a, the terminal 23b1, the connection part 23b2, and the connection portion of the cable 25 with the terminal 23b1.

The protection part 24 has, for example, a function of insulating the heating element 23a, the wiring 23b, and the connection portion of the cable 25 with the terminal 23b1, a function of transmitting heat generated in the heating element 23a to the outside, and a function of protecting the heating element 23a, the wiring 23b, and the connection portion of the cable 25 and the terminal 23b1 from external force and the liquid 100 to be heated.

The protection part 24 is made of a material having heat resistance and insulating properties, and high chemical stability and thermal conductivity. The protection part 24 is made of glass, for example. In this case, the protection part 24 can also be formed using glass to which a filler including a material having higher thermal conductivity than glass, such as aluminum oxide, is added. The thermal conductivity of glass to which a filler is added can be, for example, 2 [W/(m·K)] or more. The thickness dimension of the protection part 24 can be, for example, about 10 μm to 60 μm.

The protection part 24 can be formed by, for example, applying a paste-like material on the insulation part 22, the heating element 23a, the wiring 23b, and the connection portion of the cable 25 and the terminal 23b1 using a screen printing method or the like, and curing the material using a firing method or the like. In a case where the base part 21 includes a material having insulating properties, the protection part 24 can be formed by, for example, applying a paste-like material on the surface 21a of the base part 21, the heating element 23a, the wiring 23b, and the connection portion of the cable 25 and the terminal 23b1 using a screen printing method or the like, and curing the material using a firing method or the like.

Also, the heater 2 can be further provided with a detection part that detects the temperature of at least one of the liquid 100 and the heating element 23a. The detection part can be provided on at least one of the surface 21a side of the base part 21 and the surface 21b side of the base part 21.

The detection part can be, for example, a thermistor or the like. The thermistor may be, for example, any of an NTC (negative temperature coefficient) thermistor, a PTC (positive temperature coefficient) thermistor, and a CTR (critical temperature resistor) thermistor.

The detection part can be formed by, for example, applying a paste-like material on the insulation part 22 using a screen printing method or the like, and curing the material using a firing method or the like. In a case where the base part 21 includes a material having insulating properties, the detection part can be formed by, for example, applying a paste-like material on the surface 21a of the base part 21 using a screen printing method or the like, and curing the material using a firing method or the like. The material of the thermistor can include, for example, manganese and cobalt, and at least one of copper and nickel.

Additionally, the thermistor can also be a chip-shaped element.

A wiring electrically connected to the detection part can also be provided. The wiring can have a terminal and a connection part, similar to the wiring 23b described above. In this case, the protection part 24 can cover the detection part and the wiring. The terminal of the wiring can be provided, for example, in the vicinity of the terminal 23b1 described above. Further, in a case where the thermistor is a chip-shaped element, the chip-shaped thermistor can be mounted on the connection part of the wiring.

Similar to the case of the heating element 23a described above, each of the pair of terminals electrically connected to the detection part is electrically connected to the controller 6 via the cable 25. In this case, the protection part 24 can cover the detection part, the terminal, the connection part, and the connection portion of the cable 25 and the terminal.

Here, the linear expansion coefficient of the base part 21 differs from the linear expansion coefficient of the insulation part 22 and the linear expansion coefficient of the protection part 24. Therefore, when the heating element 23a generates heat, for example, thermal stress occurs between the base part 21, and the insulation part 22 and the protection part 24, and large warping may occur in the heater 2.

In this case, as shown in FIG. 3, in a case where the protection part 24 is provided also on the surface 21b of the base part 21, the thermal stress generated on the surface 21a side of the base part 21 can be offset by the thermal stress generated on the surface 21b side of the base part 21. Therefore, occurrence of warping in the heater 2 can be suppressed.

The container 3 has a space inside to which the liquid 100 is supplied. The external shape of the container 3 is not particularly limited. For example, the external shape of the container 3 may be a rectangular parallelepiped, a cylinder, a prism, a sphere, or the like. The external shape of the container 3 illustrated in FIG. 1 is a rectangular parallelepiped. Additionally, the container 3 may be bent or curved. The external shape of the container 3 can be appropriately changed according to the environment in which the container 3 is installed.

As shown in FIG. 1, the container 3 is provided with a supply pipe 3a and a discharge pipe 3b. For example, the supply pipe 3a can be provided at one end portion of the container 3 in the X direction. The discharge pipe 3b can be provided at the other end portion of the container 3 in the X direction.

As shown in FIG. 1, the heater 2 is provided in the space inside the container 3. In the X direction, the heater 2 extends from one inner wall side of the container 3 toward the other inner wall side. Therefore, the heating element 23a and the protection part 24 provided in the heater 2 are immersed in the liquid 100 supplied to the space inside the container 3, and the liquid 100 flows along the longitudinal direction of the heater 2. In this way, the heating efficiency for the liquid 100 can be improved.

The supply part 5 is connected to the supply pipe 3a of the container 3 via piping or the like. The supply part 5 supplies the liquid 100 to the inside of the container 3. The supply part 5 can include, for example, a tank and a pump. The supply part 5 may be factory piping or the like that supplies the liquid 100.

The controller 6 controls the operation of each element provided in the liquid heating device 1. The controller 6 can include, for example, a computer, a temperature control device, and a power source.

For example, the controller 6 is electrically connected to the supply part 5 and the heater 2. In a case where the heater 2 is further provided with a detection part such as a thermistor, the controller 6 is further electrically connected to the detection part.

For example, the controller 6 can perform temperature control of the liquid 100 by controlling the electric power applied to the heating element 23a. Further, in a case where a detection part is provided, the controller 6 can control the electric power applied to the heating element 23a based on a signal from the detection part, and thus perform temperature control of the liquid 100.

The controller 6 can stop application of electric power to the heating element 23a or reduce the electric power applied to the heating element 23a in a case where the temperature detected by the detection part exceeds a predetermined temperature. In this case, the controller 6 can also issue an alarm or the like.

In addition, the controller 6 controls, for example, the supply part 5 to control the flow rate of the liquid 100 supplied to the space inside the container 3, and thus the flow rate of the heated liquid 100 discharged from the container 3.

For example, in a case where the liquid 100 heated by the heater 2 is consumed as in hot water device, a tank 200 for storing the heated liquid 100, a nozzle for discharging the heated liquid 100, or like can be connected to the discharge pipe 3b of the container 3 via piping or the like.

Furthermore, in a case where the liquid 100 is used as a heat medium, the heated liquid 100 can be supplied to a member 300 that is to be heated. For example, in a case where the temperature of a battery mounted in an EV (Electric Vehicle) becomes too low, the speed of chemical reaction occurring within the battery becomes slow, and the amount of electricity that can be generated decreases. In such a case, the heated liquid 100 (for example, heated coolant liquid or the like) can be supplied to the outer wall, etc. of the battery to keep the temperature of the battery within an appropriate range.

In addition, in a case where the liquid 100 is used as a heat medium, the liquid 100 discharged from the member 300 (the liquid 100 used for heating the member 300) can be recovered and reused. For example, the liquid 100 discharged from the member 300 may be returned to the tank of the supply part 5. In this way, the liquid 100 circulates between the member 300 and the tank. Therefore, consumption of the liquid 100 can be suppressed, or power consumption of the heater 2 can be suppressed by reheating the liquid 100 having a high temperature.

Here, as described above, the heater 2 is provided in the space inside the container 3. Therefore, the heater 2 is immersed in the liquid 100 supplied to the space inside the container 3. In this case, since the heating element 23a, the wiring 23b, the connection portion between the cable 25 and the terminal 23b1, and the connection portion between the cable 25 and the terminal of the detection part are covered by the protection part 24, the liquid 100 can be suppressed from reaching these.

In addition, the cable 25 is drawn to the outside of the container 3 via a hole provided in the container 3, and is electrically connected to the controller 6.

Therefore, as shown in FIG. 1, the sealing part 4 that liquid-tightly seals between the hole of the container 3 and the cable 25 is provided.

The sealing part 4 can be formed by, for example, supplying a liquid material between the hole of the container 3 and the cable 25, and curing the liquid material. Additionally, for example, the sealing part 4 that has an annular or cylindrical shape can be provided between the hole of the container 3 and the cable 25.

The material of the sealing part 4 preferably has insulating properties and a certain degree of elasticity. For example, the material of the sealing part 4 can be fluorine resin, silicone resin (silicon resin), or the like.

Here, the installation position of the sealing part 4 can be arbitrarily set according to, for example, the position of the controller 6 with respect to the container 3. Moreover, in a case where the sealing part 4 is provided, the liquid 100 supplied to the space inside the container 3 can be suppressed from leaking to the outside of the container 3.

However, in a case where the liquid heating device 1 is provided in a vehicle such as an automobile, vibration accompanying traveling may be applied to the container 3. Therefore, a slight gap may occur over time between the sealing part 4 and the container 3, and/or between the sealing part 4 and the cable 25. In a case where a gap occurs between these, the liquid 100 may leak to the outside of the container 3 via the gap. In a case where the liquid 100 leaks to the outside of the container 3, members around the container 3 may corrode or the periphery of the container 3 may become dirty.

Thus, as shown in FIG. 1, the sealing part 4 can be provided at the end portion on the upper side in the gravity direction of the container 3. In this way, even in a case where a slight gap occurs between the sealing part 4 and the container 3, and/or between the sealing part 4 and the cable 25, the liquid 100 can be suppressed from leaking to the outside of the container 3 via the gap.

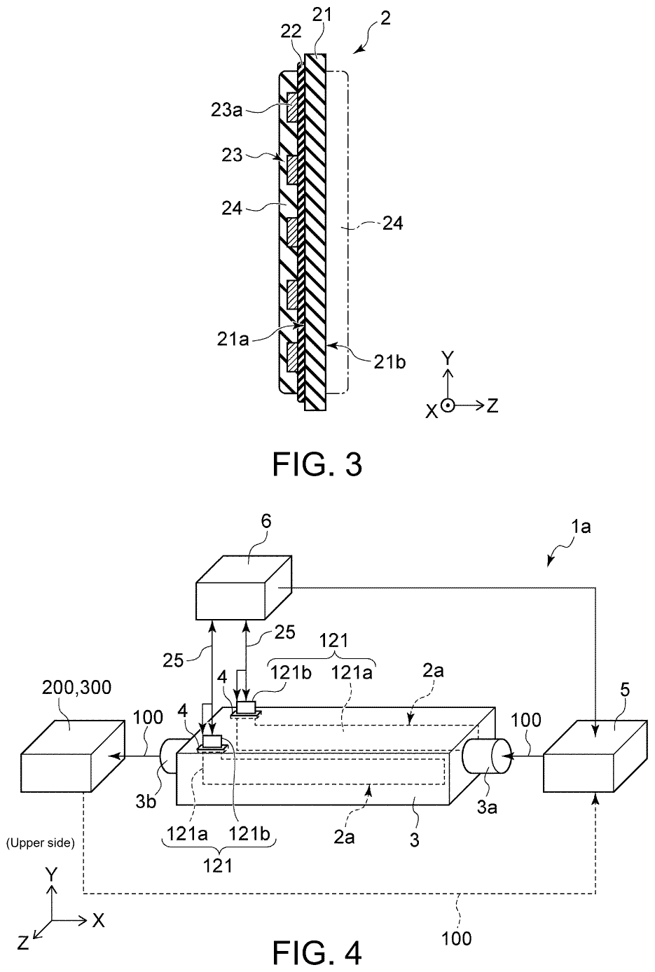

FIG. 4 is a schematic perspective view for illustrating a liquid heating device 1a according to another embodiment.

In FIG. 4, the Y direction is set as the upper side in the gravity direction.

As shown in FIG. 4, the liquid heating device 1a includes, for example, a heater 2a, a container 3, a sealing part 4, a supply part 5, and a controller 6.

As one example, FIG. 4 illustrates a case where two heaters 2a are provided. However, the number of heaters 2a is not limited thereto. At least one heater 2a may be provided.

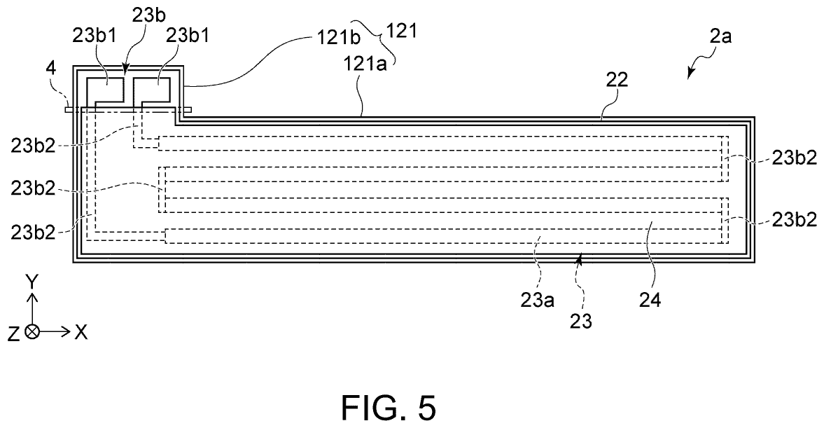

FIG. 5 is a schematic plan view of the heater 2a when viewed from the side where a heat generation part 23 is provided.

As shown in FIG. 5, the heater 2a has, for example, a base part 121, an insulation part 22, the heat generation part 23, and a protection part 24.

As shown in FIG. 4 and FIG. 5, the base part 121 has a plate shape, and includes a first portion 121a and a second portion 121b. The first portion 121a and the second portion 121b can be formed integrally. The materials of the first portion 121a and the second portion 121b can be, for example, the same as the material of the base part 21 described above.

The first portion 121a extends, for example, in the X direction. The first portion 121a can be, for example, the same as the base part 21 described above. The first portion 121a is provided in a space inside the container 3.

The second portion 121b is provided at the periphery of the first portion 121a. The second portion 121b is exposed to the outside of the container 3. For example, in a case where the heater 2a is provided in the space inside the container 3, the second portion 121b can be positioned on the upper side in the gravity direction with respect to the first portion 121a. In the liquid heating device 1a illustrated in FIG. 4, the Y direction is the upper side in the gravity direction, so the second portion 121b is provided at one end portion of the first portion 121a in the Y direction.

The shape of the second portion 121b when viewed from the Z direction is not particularly limited. In the heater 2a illustrated in FIG. 4 and FIG. 5, the shape of the second portion 121b when viewed from the Z direction is substantially rectangular.

As shown in FIG. 5, in a case where the first portion 121a and the second portion 121b include a metal, the insulation part 22 covers at least a region where the heat generation part 23 is provided of the first portion 121a and the second portion 121b.

In this case, a heating element 23a and a connection part 23b2 are provided on the insulation part 22 provided on the first portion 121a. Further, a pair of terminals 23b1 are provided on the insulation part 22 provided on the second portion 121b.

The protection part 24 is provided, for example, on the insulation part 22, and covers the heating element 23a and the connection part 23b2. In this case, the terminals 23b1 provided on the second portion 121b are exposed from the protection part 24.

In a case where the first portion 121a and the second portion 121b include a material having insulating properties, the heating element 23a and the connection part 23b2 are provided on one surface of the first portion 121a. The pair of terminals 23b1 are provided on one surface of the second portion 121b.

The protection part 24 is provided, for example, on one surface of the first portion 121a and one surface of the second portion 121b, and covers the heating element 23a and the connection part 23b2. In this case, the terminals 23b1 provided on the second portion 121b are exposed from the protection part 24.

That is, the heating element 23a is provided on one side of the first portion 121a (corresponding to one example of the first side). The terminals 23b1 are provided on one side of the second portion 121b (corresponding to one example of the first side). The connection part 23b2 is provided on one side of the first portion 121a and the second portion 121b (corresponding to one example of the first side). The protection part 24 is provided on one side of the first portion 121a and the second portion 121b (corresponding to one example of the first side).

Similar to the heater 2 described above, a detection part that detects the temperature of at least one of the liquid 100 and the heating element 23a, and a protection part 24 provided on the side of the base part 121 opposite to the side where the heat generation part 23 is provided can be further provided.

As shown in FIG. 4, when attaching the heater 2a to the container 3, the first portion 121a is provided in the space inside the container 3, so the liquid 100 flowing through the space inside the container 3 can be heated by the heating element 23a provided on the first portion 121a. Therefore, the heating efficiency for the liquid 100 can be improved.

Furthermore, since the terminals 23b1 provided on the second portion 121b are exposed to the outside of the container 3, the insulation treatment for the connection portion between the terminals 23b1 and the cable 25 becomes easy, and maintainability of the liquid heating device 1a can be improved. In addition, the terminals 23b1 and the cable 25 can be detachably connected via, for example, a waterproof connector or the like. The terminal of the detection part can also be provided on the second portion 121b. The connection between the terminal of the detection part and the cable 25 can be similar to the connection between the terminals 23b1 and the cable 25.

As shown in FIG. 4, the container 3 is provided with a hole for exposing the second portion 121b. The sealing part 4 is provided between the hole of the container 3 and the second portion 121b. The sealing part 4 liquid-tightly seals between the hole of the container 3 and the second portion 121b.

The sealing part 4 can be formed by, for example, supplying a liquid material between the hole of the container 3 and the second portion 121b, and curing the liquid material. Additionally, for example, the sealing part 4 that has an annular or cylindrical shape can be provided between the hole of the container 3 and the second portion 121b.

Similar to the case of the liquid heating device 1 described above, the sealing part 4 can be provided at the end portion on the upper side in the gravity direction of the container 3. In this way, even in a case where a slight gap occurs between the sealing part 4 and the container 3, and/or between the sealing part 4 and the second portion 121b, the liquid 100 can be suppressed from leaking to the outside of the container 3 via the gap.

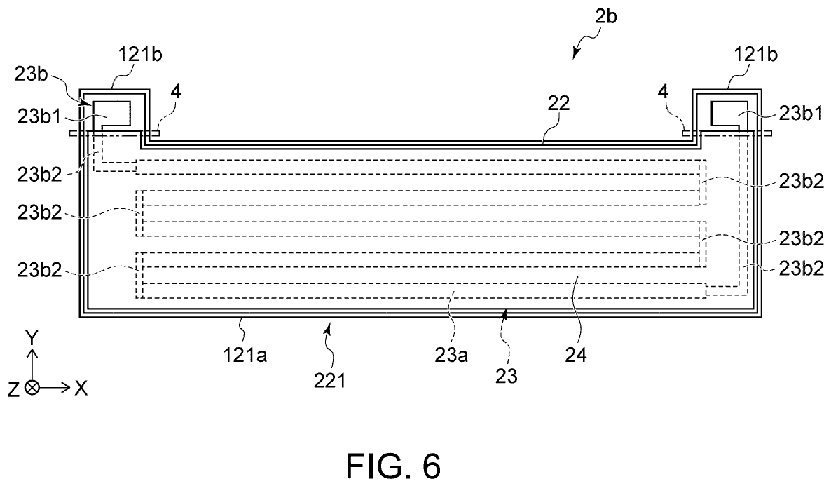

FIG. 6 is a schematic plan view of a heater 2b according to another embodiment when viewed from the side where a heat generation part 23 is provided.

As shown in FIG. 6, the heater 2b includes, for example, a base part 221, an insulation part 22, the heat generation part 23, and a protection part 24.

The configuration and material of the base part 221 can be similar to the configuration and material of the base part 121 described above. However, in the case of the base part 121 illustrated in FIG. 5, one second portion 121b is provided at one end portion in the Y direction of the first portion 121a. In contrast, in the case of the base part 221, as shown in FIG. 6, two second portions 121b are provided at one end portion in the Y direction of the first portion 121a. In addition, the two second portions 121b are separated in the X direction. In a case where the two second portions 121b are separated in the X direction, as shown in FIG. 6, the distance between the terminals 23b1 can be increased, thereby increasing the dielectric strength. Since the voltage applied to the heating element 23a can be increased, the heat generation amount can be increased.

Even in a case where the second portions 121b are arranged with respect to the first portion 121a in this manner, the sealing part 4 can be provided between the hole of the container 3 and the second portions 121b. In this case, the configuration, material, effects, etc. of the sealing part 4 can be similar to those described above.

Although the above illustrates a case where the heat generation part 23 and the protection part 24 are provided on one side in the Z direction of the base part 21, 121, 221, the heat generation part 23 and the protection part 24 can also be provided on both sides in the Z direction of the base part 21, 121, 221.

Here, the container 3 illustrated in FIG. 1 and FIG. 4 extends in the substantially horizontal direction. However, there are cases where the container 3 extends in the substantially gravity direction.

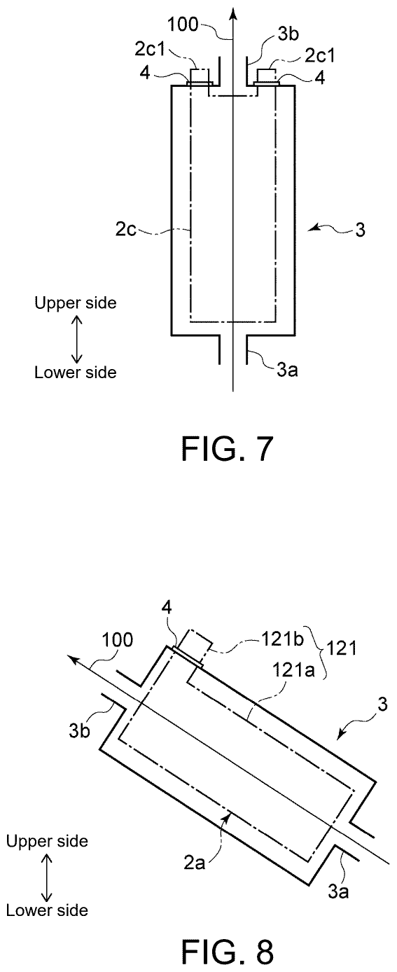

FIG. 7 is a schematic view for illustrating the container 3 extending in the substantially gravity direction.

As shown in FIG. 7, the container 3 extends in the substantially gravity direction. A heater 2c is provided in the space inside the container 3, and extends in the substantially gravity direction.

Even in such a case, a second portion 2c1 of the heater 2c, on which the terminal is provided, is exposed to the outside from the end portion on the upper side in the gravity direction of the container 3. In this case, the second portion 2c1 can be provided at the end portion in the longitudinal direction of the heater 2c.

Additionally, in a case where the heater is provided inside the container 3 that extends in the substantially gravity direction, a cable 25 joined to the terminal of the heater is drawn to the outside from the end portion on the upper side in the gravity direction of the container 3.

Therefore, even in these cases, the sealing part 4 is provided at the end portion on the upper side in the gravity direction of the container 3.

In a case where the sealing part 4 is provided at the end portion on the upper side in the gravity direction of the container 3, even if a slight gap occurs between the sealing part 4 and the container 3, between the sealing part 4 and the second portion 121b, and/or between the sealing part 4 and the cable 25, the liquid 100 can be suppressed from leaking to the outside of the container 3 via the gap.

In FIG. 7, a supply pipe 3a is provided at the end portion on the lower side in the gravity direction of the container 3, and a discharge pipe 3b is provided at the end portion on the upper side in the gravity direction of the container 3, but the arrangement of the supply pipe 3a and the discharge pipe 3b can be appropriately changed. For example, the discharge pipe 3b can be provided at the end portion on the lower side in the gravity direction of the container 3, and the supply pipe 3a can be provided at the end portion on the upper side in the gravity direction of the container 3. Furthermore, the supply pipe 3a and the discharge pipe 3b can be provided at a distance in the gravity direction at the end portion in the horizontal direction of the container 3.

In addition, the container 3 may extend in a direction inclined with respect to the horizontal direction.

FIG. 8 is a schematic view for illustrating the container 3 extending in a direction inclined with respect to the horizontal direction.

As shown in FIG. 8, the container 3 extends in a direction inclined with respect to the horizontal direction. The heater 2a is provided in the space inside the container 3, and extends in a direction inclined with respect to the horizontal direction.

Even in such a case, the second portion 121b of the heater 2a, on which the terminal 23b1 is provided, is exposed to the outside from the end portion on the upper side in the gravity direction of the container 3.

In addition, in a case where the heater is provided inside the container 3 that extends in a direction inclined with respect to the horizontal direction, a cable 25 joined to the terminal of the heater is drawn to the outside from the end portion on the upper side in the gravity direction of the container 3.

Therefore, even in these cases, the sealing part 4 is provided at the end portion on the upper side in the gravity direction of the container 3.

In a case where the sealing part 4 is provided at the end portion on the upper side in the gravity direction of the container 3, even if a slight gap occurs between the sealing part 4 and the container 3, between the sealing part 4 and the second portion 121b, and/or between the sealing part 4 and the cable 25, the liquid 100 can be suppressed from leaking to the outside of the container 3 via the gap.

Although several embodiments of the disclosure have been illustrated above, these embodiments are presented as examples and are not intended to limit the scope of the disclosure. These novel embodiments can be implemented in various other forms, and various omissions, substitutions, and changes can be made without departing from the gist of the disclosure. These embodiments and modification examples thereof are included in the scope and gist of the disclosure, and are included in the disclosure defined by the claims and the equivalent scope thereof. The respective embodiments described above can also be implemented in combination with each other.

What is claimed is:

1. A liquid heating device, comprising:
a container having a space inside to which a liquid is supplied;
a base part having a plate shape, and comprising a first portion provided in the space inside the container, and a second portion provided at a periphery of the first portion and exposed to outside of the container;
a heating element provided on a first side of the first portion;
a terminal provided on the first side of the second portion;
a connection part provided on the first side of the first portion and the second portion, and electrically connected to the heating element and the terminal;
a protection part provided on the first side of the first portion and the second portion, covering the heating element and the connection part, and exposing the terminal; and
a sealing part provided between the container and the second portion,
wherein the sealing part is provided at an end portion on an upper side in a gravity direction of the container.

2. The liquid heating device according to claim 1, wherein the first portion and the heating element extend in a first direction.

3. The liquid heating device according to claim 1, wherein the base part comprises a metal, and
the liquid heating device further comprises an insulation part provided between the base part and the heating element, the terminal, and the connection part.

4. A liquid heating device, comprising:
a container having a space inside to which a liquid is supplied;
a base part having a plate shape, and provided in the space inside the container;
a heating element provided on a first side of the base part;
a terminal provided on the first side of the base part;
a connection part provided on the first side of the base part, and electrically connected to the heating element and the terminal;
a cable electrically connected to the terminal, and drawn to outside of the container;
a protection part provided on the first side of the base part, and covering the heating element, the terminal, the connection part, and a connection portion of the cable with the terminal; and
a sealing part provided between the container and the cable,
wherein the sealing part is provided at an end portion on an upper side in a gravity direction of the container.

5. The liquid heating device according to claim 4, wherein the base part and the heating element extend in a first direction.

6. The liquid heating device according to claim 4, wherein the base part comprises a metal, and
the liquid heating device further comprises an insulation part provided between the base part and the heating element, the terminal, and the connection part.
